(19) United States
(12) Patent Application Publication
(10) Pub. No.: US 2026/0326601 A1
(43) Pub. Date: Oct. 22, 2026

(54) FAST CHARGE CONTROL WITH A MODIFIED EQUIVALENT CIRCUIT MODEL

(71) Applicant: GM Global Technology Operations LLC, Detroit, MI (US)

(72) Inventors: Taylor Reed Garrick, Bloomfield Hills, MI (US); Brian J. Koch, Berkley, MI (US); Samantha Benson, Royal Oak, MI (US); Erin Efimoff, Oak Park, MI (US); Kevin Steinhouse, Wixom, MI (US); Nicholas Carr, Bloomfield Hills, MI (US)

(73) Assignee: GM Global Technology Operations LLC, Detroit, MI (US)

(21) Appl. No.: 19/180,541

(22) Filed: Apr. 16, 2025

(51) Int. Cl. B60L 53/62; H02J 7/00

(52) U.S. Cl. CPC B60L 53/62; H02J 7/933

(57) ABSTRACT

The method includes receiving a cathode voltage response predicted by a cathode equivalent circuit model (ECM) of a battery cell, and an anode voltage response predicted by an anode ECM of the battery cell. The method also includes determining a cathode resistance voltage drop across a cathode ohmic resistor, an anode resistance voltage drop across an anode ohmic resistor, a cathode electrode voltage drop across a cathode resistor-capacitor and an anode electrode voltage drop across an anode resistor-capacitor. The method also includes determining whether a cathode potential exceeds a cathode potential threshold, and whether an anode potential falls below an anode potential threshold. When the cathode potential exceeds the cathode threshold potential, or the anode potential falls below the anode potential threshold, the method includes modifying a charging current supplied to the battery cell.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to fast charge control with a modified equivalent circuit model. In particular, electric vehicle (EV) fast charging is a process that allows EV batteries to be charged at a significantly higher rate compared to standard charging methods. This is typically achieved by using direct current (DC) fast chargers, which can deliver power levels ranging from 50 kW to over 350 kW. The fast-charging process involves sophisticated power electronics and communication protocols between the charging station and the vehicle's systems that manage the charging parameters, such as voltage, current, and temperature. Fast charging is particularly beneficial for reducing the downtime associated with charging, making EVs more convenient for long-distance travel and daily use.

However, accurate monitoring and control of the fast charge parameters is necessary to limit risks associated with the process. For instance, there is potential for the EV battery to overheat, which can affect the performance of the battery and contribute to the degradation of the battery. Additionally, improper management of charging parameters can result in lithium plating, a phenomenon where lithium ions deposit on the anode surface instead of intercalating into the anode material. This can reduce the battery's capacity, increase internal resistance, and ultimately shorten the battery's lifespan. Therefore, precise monitoring and regulation of fast charge parameters are essential to mitigate these risks and ensure the optimal performance and durability of EV batteries.

### SUMMARY

One aspect of the disclosure provides a computer-implemented method for a fast charge control with a modified equivalent circuit model that when executed on data processing hardware causes the data processing hardware to perform operations that include receiving a cathode voltage response predicted by a cathode equivalent circuit model (ECM) of a battery cell, the cathode ECM including a cathode open circuit voltage (OCV), a cathode ohmic resistor, and at least one cathode resistor-capacitor pair, and receiving an anode voltage response predicted by an anode ECM of the battery cell, the anode ECM including an anode OCV, an anode ohmic resistor, and at least one anode resistor-capacitor pair. The operations also include determining a cathode resistance voltage drop across the cathode ohmic resistor, determining an anode resistance voltage drop across the anode ohmic resistor, determining a cathode electrode voltage drop across the at least one cathode resistor-capacitor pair, and determining an anode electrode voltage drop across the at least one anode resistor-capacitor pair. The operations further include determining, based on the cathode resistance voltage drop and the cathode electrode voltage drop, whether a cathode potential of the battery cell exceeds a cathode potential threshold, and determining, based on the anode resistance voltage drop and the anode electrode voltage drop, whether an anode potential of the battery cell falls below an anode potential threshold. When one or more of the cathode potential of the battery cell exceeds the cathode threshold potential, or the anode potential of the battery cell falls below the anode potential threshold, the operations also include modifying a charging current supplied to the battery cell.

Implementations of the disclosure may include one or more of the following optional features. In some implementations, the operations further include determining a cathode state of lithiation and an anode state of lithiation, generating a modified anode state of lithiation based on an equilibrium potential of the battery cell, and generating a modified cathode state of lithiation based on the equilibrium potential of the battery cell. In these implementations, determining whether the cathode potential of the battery cell exceeds the cathode potential threshold is further based on the modified cathode state of lithiation. Additionally or alternatively, determining whether the anode potential of the battery cell falls below the anode potential threshold is further based on the modified anode state of lithiation.

In some examples, a resistance measured by the cathode ohmic resistor is modified by a Butler-Volmer analogue. In some implementations, a resistance measured by the anode ohmic resistor is modified by a Butler-Volmer analogue. In some examples, the operations further include measuring a resistance of the at least one cathode resistor-capacitor pair and dynamically updating the capacitor of the at least one cathode resistor-capacitor pair based on the measured resistance and a time constant.

In some implementations, the operations further include measuring a resistance of the at least one anode resistor-capacitor pair and dynamically updating the capacitor of the at least one anode resistor-capacitor pair based on the measured resistance and a time constant. In some examples, the operations further include receiving a separator overpotential measured by a separator ECM of the battery cell and generating, based on the separator overpotential and the anode potential, a virtual reference electrode of the battery cell. In some implementations, the battery cell powers a vehicle.

Another aspect of the disclosure provides a system including data processing hardware and memory hardware in communication with the data processing hardware. The memory hardware stores instructions that when executed by the data processing hardware cause the data processing hardware to perform operations that include receiving a cathode voltage response predicted by a cathode equivalent circuit model (ECM) of a battery cell, the cathode ECM including a cathode open circuit voltage (OCV), a cathode ohmic resistor, and at least one cathode resistor-capacitor pair, and receiving an anode voltage response predicted by an anode ECM of the battery cell, the anode ECM including an anode OCV, an anode ohmic resistor, and at least one anode resistor-capacitor pair. The operations also include determining a cathode resistance voltage drop across the cathode ohmic resistor, determining an anode resistance voltage drop across the anode ohmic resistor, determining a cathode electrode voltage drop across the at least one cathode resistor-capacitor pair, and determining an anode electrode voltage drop across the at least one anode resistor-capacitor pair. The operations further include determining, based on the cathode resistance voltage drop and the cathode electrode voltage drop, whether a cathode potential of the battery cell exceeds a cathode potential threshold, and determining, based on the anode resistance voltage drop and the anode electrode voltage drop, whether an anode potential of the battery cell falls below an anode potential threshold. When one or more of the cathode potential of the battery cell exceeds the cathode threshold potential, or the anode potential of the battery cell falls below the anode potential threshold, the operations also include modifying a charging current supplied to the battery cell.

This aspect may include one or more of the following optional features. In some implementations, the operations further include determining a cathode state of lithiation and an anode state of lithiation, generating a modified anode state of lithiation based on an equilibrium potential of the battery cell, and generating a modified cathode state of lithiation based on the equilibrium potential of the battery cell. In these implementations, determining whether the cathode potential of the battery cell exceeds the cathode potential threshold is further based on the modified cathode state of lithiation. Additionally or alternatively, determining whether the anode potential of the battery cell falls below the anode potential threshold is further based on the modified anode state of lithiation.

In some examples, a resistance measured by the cathode ohmic resistor is modified by a Butler-Volmer analogue. In some implementations, a resistance measured by the anode ohmic resistor is modified by a Butler-Volmer analogue. In some examples, the operations further include measuring a resistance of the at least one cathode resistor-capacitor pair and dynamically updating the capacitor of the at least one cathode resistor-capacitor pair based on the measured resistance and a time constant.

In some implementations, the operations further include measuring a resistance of the at least one anode resistor-capacitor pair and dynamically updating the capacitor of the at least one anode resistor-capacitor pair based on the measured resistance and a time constant. In some examples, the operations further include receiving a separator overpotential measured by a separator ECM of the battery cell and generating, based on the separator overpotential and the anode potential, a virtual reference electrode of the battery cell. In some implementations, the battery cell powers a vehicle.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system using a fast charge control with a modified equivalent circuit model.

FIG. 2 is a schematic view of example components of the system of FIG. 1.

FIG. 3 is a fast charge control model flowchart for the system of FIG. 1.

FIG. 4 is a flowchart of an example arrangement of operations for a method of fast charge control with a modified equivalent circuit model.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

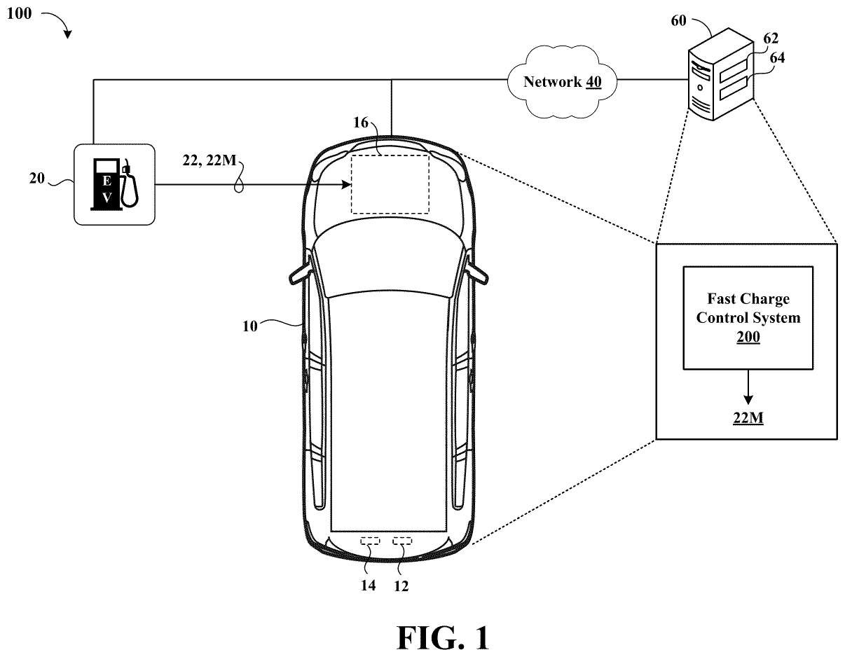

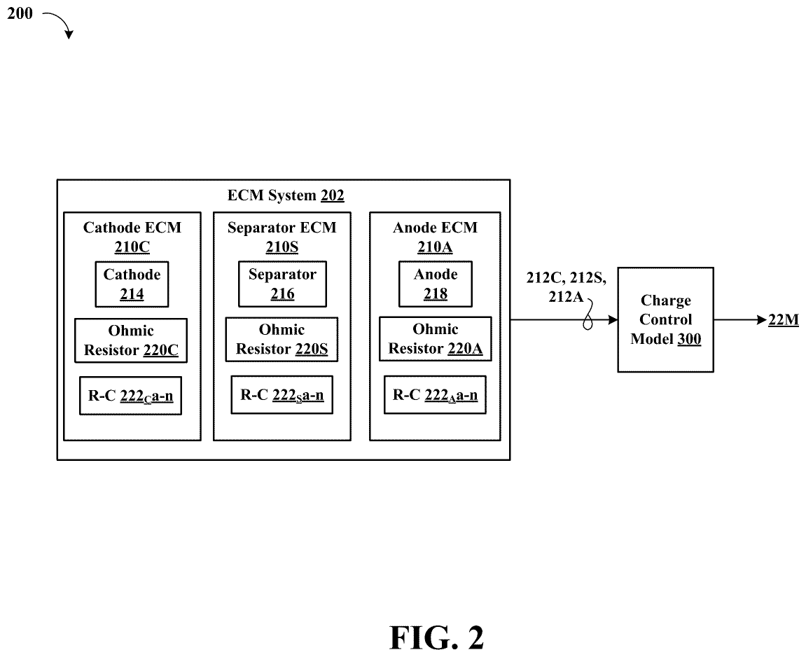

Referring to FIG. 1, in some implementations, a system 100 includes a vehicle 10, a charging station 20 (e.g., an electric vehicle (EV) charging station 20), and/or a remote system 60 in communication with one another via a network 40. As shown, the vehicle 10 is connected to the charging station 20 as it supplies a charging current 22 to a battery cell 16 of the vehicle 10. The vehicle 10 and/or the remote system 60 execute a fast charge control system 200 (FIG. 2) including an equivalent circuit model (ECM) system 202 configured to predict a voltage response 212C, 212S, 212A of one or more ECMs 210C, 210S, 210A, and modify the charging current 22 currently supplied to the battery cell 16 of the vehicle 10 when one or more of the voltage responses 212 indicate that the battery cell 16 is at risk of overheating, lithium plating, and/or violating operational voltage limits. Advantageously, because the individual voltage responses 212C, 212S, 212A are measurable/predictable, the terminal voltage response for the battery cell 16 can also be predicted. By knowing the anode potential of the battery cell 16, the fast charge control system 200 may control the charging current 22 to a minimum voltage to limit lithium plating. Likewise, by knowing the cathode potential of the battery cell 16, the fast charge control system 200 may control the charging current 22 to a maximum voltage to avoid cathode material degradation or gas generation.

In the examples shown, the fast charge control system 200 is implemented within the vehicle 10. However, the fast charge control system 200 can be implemented on other computing devices (e.g., computing devices in communication with the vehicle 10), such as, without limitation, a smart phone, tablet, smart display, desktop/laptop, smart watch, smart appliance, or smart glasses/headset. The vehicle 10 includes data processing hardware 12 and memory hardware 14 storing instructions that when executed on the data processing hardware 12 cause the data processing hardware 14 to perform operations. The vehicle 10 further includes the battery cell 16 (i.e., a cell grouping of a battery pack) that supplies power to drive the vehicle 10. The battery cell 16 may include a cathode, an anode, and a separator between the cathode and the anode.

The network 40 may include a wireless local area network (WLAN) that facilitates communication and interoperability between the vehicle 10 and the remote system 60 within an environment of the vehicle 10. Thus, the network 40 can include Wireless Fidelity (WiFi®) (e.g., IEEE 802.11), Low-Rate Wireless Personal Area Networks (e.g., IEEE 802.15.4), worldwide interoperability for microwave access (WiMAX), 3G, 4G, Long Term Evolution (LTE), 5G, digital subscriber line (DSL), Bluetooth, Near Field Communication (NFC), or any other wireless standards, or Ethernet (e.g., IEEE 802.3). The system 100 may additionally include one or more access points (AP) (not shown) configured to facilitate wireless communication between the vehicle 10 and the remote system 60.

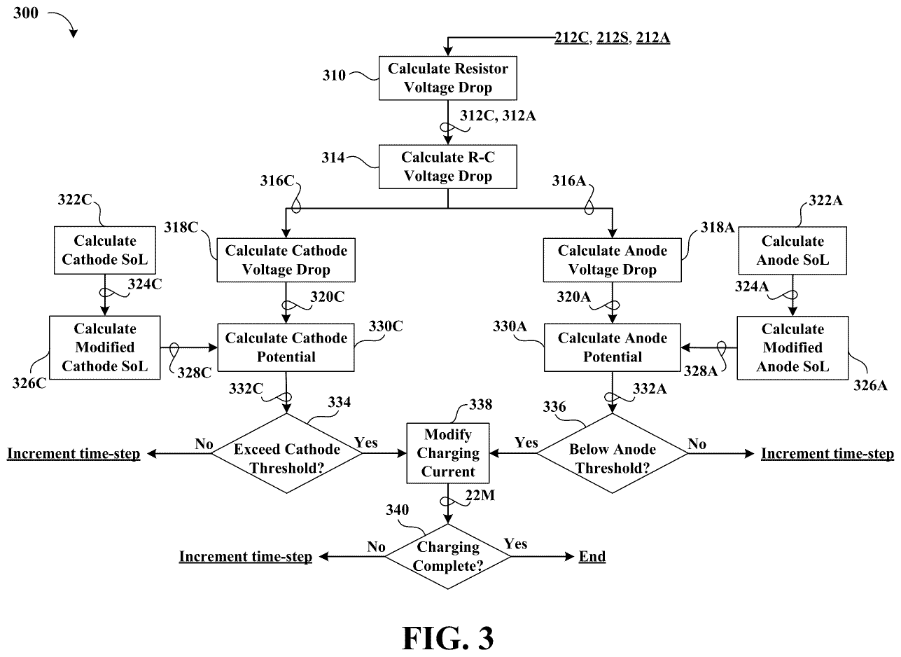

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the fast charge control system 200 is shared across the vehicle 10 and the remote system 60. As described in greater detail below with reference to FIGS. 2 and 3, the fast charge control system 200 executing on the vehicle 10 and/or the remote system 60 executes an ECM system 202 and a charge control model 300. Here, the voltage responses 212 predicted by the ECM system 202 may be used by the charge control model 300 to modify the charging current 22 supplied to the battery cell 16 of the vehicle.

With particular reference to FIG. 2, the ECM system 202 may include a cathode ECM 210C, an anode ECM 210A, and a separator ECM 210S. As shown, the cathode ECM 210C includes a cathode open circuit voltage (OCV) 214 (also referred to as a cathode 214), a cathode ohmic resistor 220C, and at least one cathode resistor-capacitor pair 222_{C}, 222_{C}a-222_{C}n. Similarly, the anode ECM 210A includes an anode OCV 218 (also referred to as an anode 218), an anode ohmic resistor 220A, and at least one anode resistor-capacitor pair 222_{A}, 222_{A}a-222_{A}n. The separator ECM 210S may include a separator electrode OCV 216, a separator ohmic resistor 220S, and at least one separator resistor-capacitor pair 222_{S}, 222_{S}a-222_{S}n. In some examples, the cathode ECM 210C is a four parameter (4P) ECM having one resistor-capacitor pair 222_{C}, the separator ECM 210S is a six parameter (6P) ECM having two resistor-capacitor pairs 222_{A}a, 222_{A}b, and the anode ECM 210A is a four parameter (4P) ECM having one resistor-capacitor pair 222_{A}. However, it should be understood that each respective ECM 210 of the ECM system 202 may include additional or fewer resistor-capacitor pairs 222 to modify the parameters of the respective ECM 210 (e.g., 4P, 6P, 8P, 10P, etc.). Moreover, each of the ECMs 210C, 210A may be run independently (i.e., decoupled) from the other.

In some instances, the parameters of each of the cathode OCV 214, the cathode ohmic resistor 220C, the at least one cathode resistor-capacitor pair 222_{C}, the anode OCV 218, the anode ohmic resistor 220A, and the at least one anode resistor-capacitor pair 222_{A} are defined by individual lookup tables. In other instances, the parameters of each of the cathode OCV 214, the cathode ohmic resistor 220C, the at least one cathode resistor-capacitor pair 222_{C}, the anode OCV 218, the anode ohmic resistor 220A, and the at least one anode resistor-capacitor pair 222_{A} are defined by algebraic equations. In either instance, these parameters may be looked up/calculated as a function of one or more of temperature, state of charge/state of lithiation, applied current, or direction of applied current (i.e., de-lithiation vs. lithiation; charge vs. current).

In some cases, the ohmic resistance measured by one or more of the cathode ohmic resistor 220C or the anode ohmic resistor 220A is modified by a Butler-Volmer analogue. Here, the Butler-Volmer analogue is applied such that the ohmic resistance is non-linear as a function of current following the curved shape of the Butler-Volmer kinetic equation. Notably, a standard ohmic resistance function does not typically capture kinetic responses and is instead constant with respect to the applied current. This application of the shape function may be applied to further consider the diffusion impact on the equilibrium potential of the battery cell 16, in contrast to the constant lookup function traditionally used to capture the relationship between the state of lithiation and the equilibrium potential of the battery cell 16.

With continued reference to FIG. 2, the ECM system 202 may generate, as output, the voltage response 212C predicted by the cathode ECM 210C, the voltage response 212A predicted by the anode ECM 210A, and the voltage response 212S predicted by the cathode ECM 210S. The charge control model 300 receives the predicted voltage responses 212C, 212A, 212S as input, and generates, as output, a modified charging current 22M for the battery cell 16 to preserve the battery cell 16 my avoiding lithium plating and overcharging of the cathode OCV 214.

Referring to FIG. 3, a flowchart of the charge control model 300 is shown. The flowchart of the charge control model 300 may execute each forward time-step t while the charging current 22 is applied to the battery cell 16 of the vehicle 10. At operation 310, the charge control model 300 calculates the cathode resistor voltage drop 312C across the cathode ohmic resistor 220C, and the anode resistor voltage drop 312 across the anode ohmic resistor 220A. The charge control model 300 may calculate the respective resistor voltage drops 312C, 312A by first calculating the ohmic resistance R0 measured by the respective ohmic resistors 220C, 220A, and applying the principles of Ohms law.

Here, the ohmic resistance R0 measured by one or more of the cathode ohmic resistor 220C or the anode ohmic resistor 220A is modified by a Butler-Volmer analogue. The Butler-Volmer analogue may be applied such that the ohmic resistance R0 is non-linear as a function of current following the curved shape of the Butler-Volmer kinetic equation. Notably, a standard ohmic resistance function does not typically capture kinetic responses and is instead constant with respect to the applied current. This application of the shape function may be applied to further consider the diffusion impact on the equilibrium potential of the battery cell 16, in contrast to the constant lookup function traditionally used to capture the relationship between the state of lithiation and the equilibrium potential of the battery cell 16.

Here, the ohmic resistance R0_{cathode} of the cathode ohmic resistor 220C and the ohmic resistance R0_{anode} of the anode ohmic resistor 220A may be respectively defined as follows:

$${VO}_{cathode} = {RO}_{cathode} * ( ( 1 - μ ) * \frac{1}{{sinh}^{- 1} ( a )} * {sinh}^{- 1} ( \frac{a * {I}_{applied}}{{I}_{reference}} ) + \frac{μ * {I}_{applied}}{{I}_{reference}} ) , and \qquad ( 1 )$$

$${VO}_{anode} = {RO}_{anode} * ( ( 1 - μ ) * \frac{1}{{sinh}^{- 1} ( a )} * {sinh}^{- 1} ( \frac{a * {I}_{applied}}{{I}_{reference}} ) + \frac{μ * {I}_{applied}}{{I}_{reference}} ) , \qquad ( 2 )$$

where V denotes voltage, I_{applied} denotes the applied current, and I_{reference} denotes the reference current. Further, a denotes the nonlinearity factor, and u denotes the ratio between linear and total resistance, where the behavior is linear when mu is equal to one (1), and the behavior is nonlinear when mu is equal to zero (0).

Thereafter, at operation 310, the charge control model 300 may apply Ohms law to the calculated ohmic resistances R0_{cathode}, R0_{anode} at the current passed (denoted as app) in the instant time-step t to determine the cathode resistance voltage drop 312C across the cathode ohmic resistor 220C and the anode resistance voltage drop 312A across the anode ohmic resistor 220A, as follows:

V_{drop_R0cathode}=iₐₚₚ*R0_{cathode} (3), and

V_{drop_R0anode}=iₐₚₚ*R0_{anode} (4).

At operation 314, the charge control model 300 determines a cathode electric voltage drop 316C across the at least one cathode resistor-capacitor pair 222_{C}, and the anode electric voltage drop 316A across the at least one anode resistor-capacitor pair 222_{A}. As should be appreciated, the charge control model 300 determines a respective electric voltage drop 316 for each resistor-capacitor pair 222 in the system 100. For example, if the cathode ECM 210C includes a single resistor-capacitor pair 222C, the charge control model 300 determines a single cathode electric voltage drop 316C across the single resistor-capacitor pair 222C. Similarly, if the anode ECM 210A includes two resistor-capacitor pairs 222_{A}a, 222_{A}b, the charge control model 300 may determine respective anode electric voltage drops 316A₁, 316A₂ for each of the two resistor-capacitor pairs 222_{A}a, 222_{A}b. The current i and voltage drop 316 across each resistor-capacitor pair 222 may be captured using an ordinary differential equation, as follows:

$${i}_{R C} = \frac{V}{R} + \frac{time}{R} * \frac{d V}{d t} , \qquad ( 5 )$$

where i_{RC} denotes the voltage drop 316 (also referred to as V_{RC}) of the resistor-capacitor pair 222, V denotes the voltage across the resistor-capacitor pair 22, R denotes the resistance of the resistance-capacitor pair 222, and time is a constant. Notably, while the parameters of an R-C pair are typically known using a lookup table, the charge control model 300 may use the resistance R of the resistor and the constant time to dynamically calculate the capacitor parameters and/or update the capacitor of the resistor-capacitor pair 222 based on the measured resistance R and the time constant time.

At operations 318C, 318A, the respective total voltage drops 320C, 320A are calculated by the charge control model 300. In particular, at operation 318C, the charge control model 300 determines, based on the cathode resistance voltage drop 312C and the cathode electrode voltage drop 316C, a total cathode voltage drop 320C of the cathode ECM 210C. At the same time, at operation 318C, the charge control model 300 determines, based on the anode resistance voltage drop 312A and the anode electric voltage drop 316A, a total anode voltage drop 320A of the anode ECM 210A. Here, the total voltage drops 320C, 320A may be respectively calculated, as follows:

V_{drop_cathode}=V_{drop_R0cathode}+V_{R1C1_cathode} (6), and

V_{drop_anode}=V_{drop_R0anode}+V_{R1C1_anode} (7).

At operation 322C, the charge control model 300 calculates the current cathode state of lithiation (SoL) 324C. Likewise, at operation 322A, the charge control model 300 calculates the current anode SoL 324A. Here, the charge control model 300 links the cathode SoL 324C and the anode SoL 324A to the cell state of charge (i.e., τ_{cell}) of each of the cathode 214 and the anode 218 using cell balancing parameters, as follows:

x_{A}=[x_{A,charged}−x_{A,discharged}|τ_{cell}+x_{A,discharged} (8), and

x_{C}=[x_{C,discharged}−x_{C,charged}]1−τ_{cell}]+x_{C,charged} (9).

During initialization of the charge control model 300, the battery cell 16 stochiometric parameters for determining the cathode SoL 324C defined as x_{C} and the anode SoL 324A defined as x_{A} may be defined as follows: X_{A,charged} denotes an anode lithiation fraction at a maximum cell state-of-charge (SoC), x_{A,discharged} denotes the anode lithiation fraction at minimum cell SoC, x_{C,charged} denotes the cathode lithiation fraction at maximum cell SoC, and x_{C,discharged} denotes the cathode lithiation fraction at minimum cell SoC.

At operation 326C, the charge control model 300 generates a modified cathode SoL 328C based on an equilibrium potential U of the battery cell 16. Specifically, the charge control model 300 may define the relationship between the equilibrium potential U and the cathode SoL 324C to modify the cathode SoL 324C. Likewise, at operation 326A, the charge control model generates a modified anode SoL 328A based on the equilibrium potential U. Here, the respective modified SoLs 328C, 328A may be calculated in real-time, as follows:

U_{cathode}=f(SoL_{cathode}+SF) (10), and

U_{anode}=f(SoL_{anode}+SF) (11),

where U_{cathode} denotes the modified cathode SoL 328C, U_{anode} denotes the modified anode SoL 328A, SoL cathode denotes the cathode SoL 324C, SoL_{anode} denotes the anode SOL 324A, and SF denotes a shift function of the battery cell 16 of the vehicle 10.

At operation 330C, the charge control model 300 receives the modified cathode SoL 328C and the previously calculated total cathode voltage drop 320C, and calculates the cathode potential 332C (i.e., V_{cathode}) of the battery cell 316, as follows:

V_{cathode}=V_{drop_cathode}+U_{cathode} (12).

Similarly, at operation 330A, the charge control model 300 receives the modified anode SoL 328A and the previously calculated total anode voltage drop 320A, and calculates the anode potential 332A of the battery cell 316, as follows:

V_{anode}=V_{drop_anode}+U_{anode} (13).

At operation 334, the charge control model 300 determines whether the cathode potential 332C exceeds a cathode potential threshold. For instance, the charge control model 300 may define the cathode potential threshold as a maximum cathode potential that avoids damage to the cathode active material in the battery cell 16. This damage may include cracking or site loss due to metals moving to occupy the lithium intercalation sites due to collapse of the structure. If the cathode potential 332C does not exceed the cathode potential threshold, the charge control model 300 may increment forward the next time-step. If, however, the cathode potential 332C does exceed the cathode potential threshold, the charge control model 300 may iterate a sweep of the current passed (i.e., iₐₚₚ) between the cathode 314 and the anode 318 until the feedforward prediction for the cathode potential 332C does not exceed the cathode potential threshold.

At operation 336, the charge control model 300 determines whether the anode potential 332A falls below an anode potential threshold. For instance, the charge control model 300 may define the anode potential threshold to avoid lithium plating. If the anode potential 332A is above the anode potential threshold, the charge control model 300 may increment forward the next time-step. Conversely, if the anode potential 332A falls below the anode potential threshold, the charge current model 300 may iterate a sweep of the current passed (i.e., iₐₚₚ) until the feedforward prediction for the anode potential 332A is above the anode potential threshold. In some implementations, the charge control model 300 receives a separator overpotential measured by the separator ECM 210S and generates, based on the separator overpotential and the calculated anode potential 332A, a virtual reference electrode of the battery cell 16.

At operation 338, when one or both of the cathode potential 332C of the battery cell 16 exceeds the cathode threshold potential and the anode potential 332A of the battery cell 16 falls below the anode potential threshold, the charge control model 300 modifies the charging current 22 supplied to the battery cell 16. Here, the modified charging current 22M may be the minimum of the respective currents passed iₐₚₚ calculated in the iterative sweeps of the current passed iₐₚₚ at operations 334, 336. This minimum may be defined by one or more of architecture limitations (e.g., busbar maximums), cell hard limits, charger limits, thermal runaway limits, not to exceed the cathode potential threshold, or not to fall below the anode potential threshold.

Thereafter, the charge control model 300 may communicate instructions to the vehicle 10 and/or the charging station to update the charging current 22 applied to the battery cell to the modified charging current 22M. At operation 340, the charge control model 300 determines whether charging of the battery cell 16 is complete (e.g., at or above 80% SoC). If the charging of the battery cell 16 is not complete, the charge control model 300 may increment forward the next time-step to continue to monitor the state of the battery cell 16. Conversely, if the charging of the battery cell 16 is complete, the charge control model 300 may end/cut off the charging current 22 to the battery cell 16.

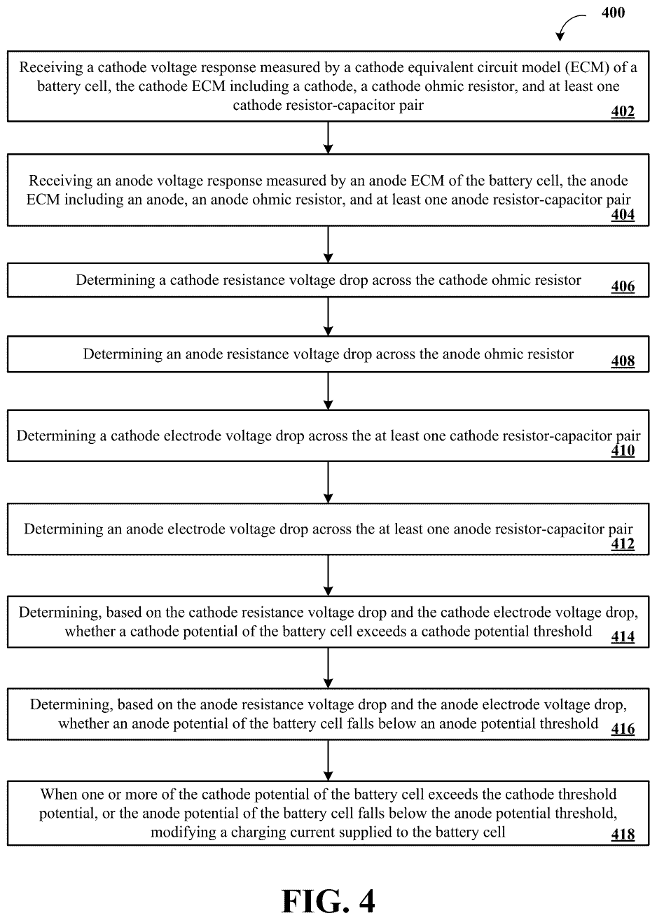

FIG. 4 shows a flowchart of an example arrangement of operations for a method 400 of fast charge control using equivalent circuit models. The method 400 may be described with reference to FIGS. 1-3. Data processing hardware (e.g., data processing hardware 12, 62 of FIG. 1) may execute instructions stored on memory hardware (e.g., memory hardware 14, 64 of FIG. 1) to perform the example arrangement of operations for the method 400. At operation 402, the method 400 includes receiving a cathode voltage response 212C predicted by a cathode equivalent circuit model (ECM) 210C of a battery cell 16. Here, the cathode ECM 210C includes a cathode OCV 214, a cathode ohmic resistor 220C, and at least one cathode resistor-capacitor (also referred to as R-C) pair 222_{C}, 222_{C}a-222_{C}n.

At operation 404, the method 400 also includes receiving an anode voltage response 212A predicted by an anode ECM 210A of the battery cell 16. Here, the anode ECM 210A includes an anode OCV 218, an anode ohmic resistor 220A, and at least one anode resistor-capacitor pair 222_{A}, 222_{A}a-222_{A}n. The method 400 also includes, at operation 406, determining a cathode resistance voltage drop 312C across the cathode ohmic resistor 220C. At operation 408, the method 400 further includes determining an anode resistance voltage drop 312A across the anode ohmic resistor 220A.

The method 400 also includes, at operation 410, determining a cathode electrode voltage drop 316C across the at least one cathode resistor-capacitor pair 222_{C}. At operation 412, the operation 400 also includes determining an anode electric voltage drop 316A across the at least one anode resistor-capacitor pair 222_{A}. At operation 414, the method 400 also includes determining, based on the cathode resistance voltage drop 312C and the cathode electric voltage drop 316C whether a cathode potential 332C of the battery cell 16 exceeds a cathode potential threshold.

At operation 416, the method 400 further includes determining, based on the anode resistance voltage drop 312A and the anode electric voltage drop 316A, whether an anode potential 332A of the battery cell falls below an anode potential threshold. When one or more of the cathode potential 332C exceeds the cathode threshold, or the anode potential 332A falls below the anode threshold, the method 400 also includes, at operation 418, modifying a charging current 22 supplied to the battery cell 16.

The operations also include determining a cathode resistance voltage drop across the cathode ohmic resistor, determining an anode resistance voltage drop across the anode ohmic resistor, determining a cathode electrode voltage drop across the at least one cathode resistor-capacitor pair, and determining an anode electrode voltage drop across the at least one anode resistor-capacitor pair. The operations further include determining, based on the cathode resistance voltage drop and the cathode electrode voltage drop, whether a cathode potential of the battery cell exceeds a cathode potential threshold, and determining, based on the anode resistance voltage drop and the anode electrode voltage drop, whether an anode potential of the battery cell falls below an anode potential threshold. When one or more of the cathode potential of the battery cell exceeds the cathode threshold potential, or the anode potential of the battery cell falls below the anode potential threshold, the operations also include modifying a charging current supplied to the battery cell.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executing on data processing hardware that causes the data processing hardware to perform operations comprising:
receiving a cathode voltage response predicted by a cathode equivalent circuit model (ECM) of a battery cell, the cathode ECM comprising a cathode open circuit voltage (OCV), a cathode ohmic resistor, and at least one cathode resistor-capacitor pair;
receiving an anode voltage response predicted by an anode ECM of the battery cell, the anode ECM comprising an anode OCV, an anode ohmic resistor, and at least one anode resistor-capacitor pair;
determining a cathode resistance voltage drop across the cathode ohmic resistor;
determining an anode resistance voltage drop across the anode ohmic resistor;
determining a cathode electrode voltage drop across the at least one cathode resistor-capacitor pair;
determining an anode electrode voltage drop across the at least one anode resistor-capacitor pair;
determining, based on the cathode resistance voltage drop and the cathode electrode voltage drop, whether a cathode potential of the battery cell exceeds a cathode potential threshold;
determining, based on the anode resistance voltage drop and the anode electrode voltage drop, whether an anode potential of the battery cell falls below an anode potential threshold; and
when one or more of the cathode potential of the battery cell exceeds the cathode threshold potential, or the anode potential of the battery cell falls below the anode potential threshold, modifying a charging current supplied to the battery cell.

2. The method of claim 1, wherein the operations further comprise:
determining a cathode state of lithiation and an anode state of lithiation;
generating a modified anode state of lithiation based on an equilibrium potential of the battery cell; and
generating a modified cathode state of lithiation based on the equilibrium potential of the battery cell.

3. The method of claim 2, wherein determining whether the cathode potential of the battery cell exceeds the cathode potential threshold is further based on the modified cathode state of lithiation.

4. The method of claim 2, wherein determining whether the anode potential of the battery cell falls below the anode potential threshold is further based on the modified anode state of lithiation.

5. The method of claim 1, wherein a resistance measured by the cathode ohmic resistor is modified by a Butler-Volmer analogue.

6. The method of claim 1, wherein a resistance measured by the anode ohmic resistor is modified by a Butler-Volmer analogue.

7. The method of claim 1, wherein the operations further comprise:
measuring a resistance of the at least one cathode resistor-capacitor pair; and
dynamically updating the capacitor of the at least one cathode resistor-capacitor pair based on the measured resistance and a time constant.

8. The method of claim 1, wherein the operations further comprise:
measuring a resistance of the at least one anode resistor-capacitor pair; and
dynamically updating the capacitor of the at least one anode resistor-capacitor pair based on the measured resistance and a time constant.

9. The method of claim 1, wherein the operations further comprise:
receiving a separator overpotential measured by a separator ECM of the battery cell; and
generating, based on the separator overpotential and the anode potential, a virtual reference electrode of the battery cell.

10. The method of claim 1, wherein the battery cell powers a vehicle.

11. A system comprising:
data processing hardware; and
memory hardware in communication with the data processing hardware, the memory hardware storing instructions that when executed on the data processing hardware cause the data processing hardware to perform operations comprising:
receiving a cathode voltage response predicted by a cathode equivalent circuit model (ECM) of a battery cell, the cathode ECM comprising a cathode open circuit voltage (OCV), a cathode ohmic resistor, and at least one cathode resistor-capacitor pair;
receiving an anode voltage response predicted by an anode ECM of the battery cell, the anode ECM comprising an anode OCV, an anode ohmic resistor, and at least one anode resistor-capacitor pair;
determining a cathode resistance voltage drop across the cathode ohmic resistor;
determining an anode resistance voltage drop across the anode ohmic resistor;
determining a cathode electrode voltage drop across the at least one cathode resistor-capacitor pair;
determining an anode electrode voltage drop across the at least one anode resistor-capacitor pair;
determining, based on the cathode resistance voltage drop and the cathode electrode voltage drop, whether a cathode potential of the battery cell exceeds a cathode potential threshold;
determining, based on the anode resistance voltage drop and the anode electrode voltage drop, whether an anode potential of the battery cell falls below an anode potential threshold; and
when one or more of the cathode potential of the battery cell exceeds the cathode threshold potential, or the anode potential of the battery cell falls below the anode potential threshold, modifying a charging current supplied to the battery cell.

12. The system of claim 11, wherein the operations further comprise:
determining a cathode state of lithiation and an anode state of lithiation;
generating a modified anode state of lithiation based on an equilibrium potential of the battery cell; and
generating a modified cathode state of lithiation based on the equilibrium potential of the battery cell.

13. The system of claim 12, wherein determining whether the cathode potential of the battery cell exceeds the cathode potential threshold is further based on the modified cathode state of lithiation.

14. The system of claim 12, wherein determining whether the anode potential of the battery cell falls below the anode potential threshold is further based on the modified anode state of lithiation.

15. The system of claim 11, wherein a resistance measured by the cathode ohmic resistor is modified by a Butler-Volmer analogue.

16. The system of claim 11, wherein a resistance measured by the anode ohmic resistor is modified by a Butler-Volmer analogue.

17. The system of claim 11, wherein the operations further comprise:
measuring a resistance of the at least one cathode resistor-capacitor pair; and
dynamically updating the capacitor of the at least one cathode resistor-capacitor pair based on the measured resistance and a time constant.

18. The system of claim 11, wherein the operations further comprise:
measuring a resistance of the at least one anode resistor-capacitor pair; and
dynamically updating the capacitor of the at least one anode resistor-capacitor pair based on the measured resistance and a time constant.

19. The system of claim 11, wherein the operations further comprise:
receiving a separator overpotential predicted by a separator ECM of the battery cell; and
generating, based on the separator overpotential and the anode potential, a virtual reference electrode of the battery cell.

20. The system of claim 11, wherein the battery cell powers a vehicle.
